(19) United States
(12) Patent Application Publication
(10) Pub. No.: US 2010/0302403 A1
(43) Pub. Date: Dec. 2, 2010

(54) Generating Images With Different Fields Of View

(75) Inventor: Ralph W. Anderson, Phoenix, AZ (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/791,234

(22) Filed: Jun. 1, 2010

Related U.S. Application Data
(60) Provisional application No. 61/183,310, filed on Jun. 2, 2009.

(51) Int. Cl. H04N 5/228

(52) U.S. Cl. 348/222.1; 348/E05.024

(57) ABSTRACT

According to one embodiment, an apparatus comprises a camera and an image processor. The camera receives light reflected from a scene and generates image data from the light, where the image data represents the scene. The image processor receives the image data and generates a first image signal according to the image data. The first image signal is operable to yield a first image representing a first field of view of the scene, The image processor generates a second image signal according to the image data. The second image signal is operable to yield a second field of view of the scene that is different from the first field of view.

### RELATED APPLICATION

This application claims benefit under 35 U.S.C. §119(e) of U.S. Provisional Application Ser. No. 61/183,310, entitled “Generating Images With Different Fields Of View,” Attorney's Docket 004578.1697 (PD 06W187), filed Jun. 2, 2009, by Ralph W. Anderson, which is incorporated herein by reference.

### TECHNICAL FIELD

This invention relates generally to the field of imaging systems and more specifically to generating images with different fields of view.

### BACKGROUND

A typical camera receives light reflected from a scene and generates an image of the scene from the light. The camera has a field of view that describes the portion of the scene that the camera can capture. Typically, the field of view is given as the angular extent of the scene.

### SUMMARY OF THE DISCLOSURE

In accordance with the present invention, disadvantages and problems associated with previous techniques for generating images with different fields of view may be reduced or eliminated.

According to one embodiment, an apparatus comprises a camera and an image processor. The camera receives light reflected from a scene and generates image data from the light, where the image data represents the scene. The image processor receives the image data and generates a first image signal according to the image data. The first image signal is operable to yield a first image representing a first field of view of the scene. The image processor generates a second image signal according to the image data. The second image signal is operable to yield a second field of view of the scene that is different from the first field of view.

Certain embodiments of the invention may provide one or more technical advantages. A technical advantage of one embodiment may be that an imaging system generates images of different fields of view. Another technical advantage of one embodiment may be that a gimbal system stabilizes the imaging system.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of an imaging system that can generate images of a scene with different fields of view;

FIGS. 2 and 3 illustrate examples of wide and narrow field of view images displayed by one embodiment of the imaging system; and

FIG. 4 illustrates one embodiment of a method for generating images of different fields of view.

### DETAILED DESCRIPTION OF THE DRAWINGS

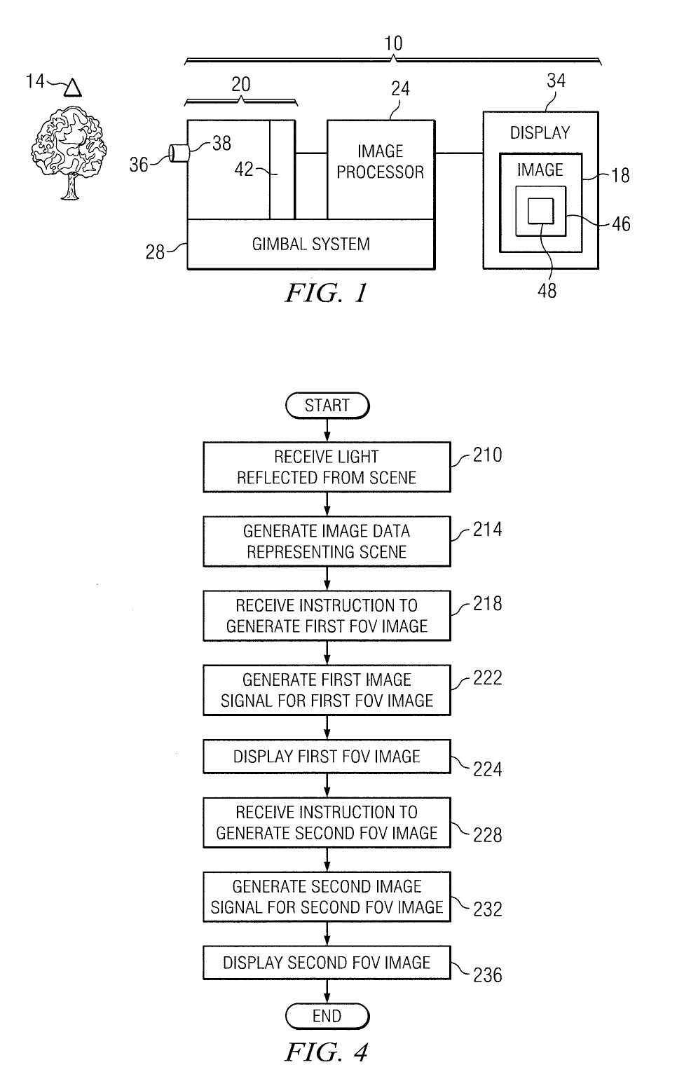

Embodiments of the present invention and its advantages are best understood by referring to FIGS. 1 through 4 of the drawings, like numerals being used for like and corresponding parts of the various drawings.

FIG. 1 illustrates an example of an imaging system 10 that can generate images 18 of a scene 14 with different fields of view. In the illustrated example, scene 14 represents a physical area of which image 18 is to be made. Scene 14 may represent, for example, an area under surveillance for military or security purposes.

Image 18 represents a visual representation of scene 14. Image 18 may comprise one or more images, for example, a still photograph or a sequence of images that form a movie or video. Imaging system 10 generates images 18 with different fields of view. The field of view (FOV) describes the angular extent of scene 14 that is imaged. The field of view may be given by a horizontal angle <h° and a vertical angle <v°, and may be written as <h° H×<v° V. Different parts of imaging system 10 may capture or generate images with different fields of view.

In the illustrated embodiment, imaging system 10 includes a camera 20, an image processor 24, a gimbal system 28, and a display 34 coupled as shown. In one example of operation, camera 20 captures image data that can be used to generate image 40 of scene 20. Image processor 24 processes the image data to generate images 40 of different fields of view. Gimbal system 38 stabilizes camera 20 and/or image processor 24. Display 34 displays images 40 of different fields of view.

As mentioned above, camera 20 captures image data that can be used to generate image 18 of scene 14. Image data may include information for pixels that can be used to form an image. The information may include brightness and/or color at a particular pixel. Horizontal rows and vertical columns of pixels form an image. Pixel area describes the number of pixels in the horizontal direction #h and the number of pixels in the vertical direction #v, and may be written as #h H×#v V. Different parts of imaging system 10 may yield image data of different pixel areas.

Camera 20 may include an aperture 38, a lens 36, and an image sensor 42. Light reflected from scene 14 enters camera 20 through aperture 38. The light may be of the visible or other portion of the electromagnetic spectrum. Lens 36 focuses the light towards image sensor 42. Image sensor 42 captures image data from the light and may comprise an array of charged-coupled devices (CCDs).

Camera 20 has a field of view. The camera field of view is affected by the dimensions of the recording surface, the focal length of lens 36, and/or the image distortion of lens 36. Image sensor 42 may capture image data with a CCD field of view <h_{ccd}° H×<v_{ccd}° V and a CCD pixel area #h_{ccd}H×#v_{ccd} V. Image processor 44 may yield image data that displays an image with a display field of view <_{dis}° H×<v_{dis}° V and a display pixel area #h_{dis}H×#v_{dis} V. The displayed image may have an active area with an active field of view <h_{act}° H×<v_{act}° V and an active pixel area #h_{act}H×#v_{act} V. The fields of view and the pixel areas may have any suitable values.

Image processor 24 processes the image data to yield images 18 of different fields of view. The image data may yield images of scene 20 with two, three, or more fields of view. In the illustrated embodiment, images 18 include a larger FOV image 46 and a smaller FOV image 48.

In one embodiment, different pixels of the image data may be used to generate the different images 18. For example, an image with a field of view that is wider in the horizontal direction may use more pixels in the horizontal direction than an image with a narrower field of view. The image with the narrower field of view may use #hₙₐᵣ pixels, where #hₙₐᵣ is equal to every nₕth pixel, nₕ>1, 2, 3, . . . , that the image with the wider field of view uses.

Similarly, an image with a field of view that is taller in the vertical direction may use more pixels in the vertical direction than an image with a shorter field of view. The image with the shorter field of view may use #vₛₕₒ pixels, where #vₛₕₒ is equal to every nᵥth pixel, nᵥ>1, 2, 3, . . . , that the image with the taller field of view uses.

The resulting field of view of an image may be determined from the field of view contributed by each pixel, or field of view per pixel, and the number of pixels used for that image. The field of view per pixel may be calculated from the active field of view in one direction divided by the number of pixels in the active pixel area in that direction. For example, the field of view per pixel is <h_{act}/#h_{act} in the horizontal direction and <v_{act}/#v_{act} in the vertical direction.

The resulting field of view of an image may be determined by multiplying the field of view per pixel by the number of pixels used for the image. For example, the resulting field of view may be <h_{act}/#v_{act}*#hₙₐᵣ in the horizontal direction and <h_{act}/#v_{act}*#vₙₐᵣ in the vertical direction. Image processor 24 may use the field of view contributed by each pixel and a requested field of view to calculate the number of pixels to use for the image.

In one embodiment, a smaller FOV image can be selected from a larger FOV image. The larger FOV image may include an outline of the smaller FOV image. A user may move the outline to designate the portion of the larger FOV image to be the smaller FOV image. The outline may be moved freely or may be restricted to certain motions, such as vertically and/or horizontally along one or more specific lines, such as a center line.

Camera 20 and image processor 24 may generate and process the image data in any suitable manner. In one embodiment, camera 20 may provide image processor 24 with first image data that yields image 18 of a first field of view and second image data that yields image 18 of a second field of view. For example, camera may have a first lens 36 that yields the first image data and a second lens 36 that yields the second image data.

In another embodiment, camera 20 may provide image processor 24 with image data that yields image 18 of a particular field of view. Image processor 24 may then process the image data to generate first image data that yields image 18 of a first field of view and second image data that yields image 18 of a second field of view.

Gimbal system 38 stabilizes camera 20 and/or image processor 24. Gimbal system 38 may include three gimbals that sense rotation about the axes of three dimensional space. Display 34 displays images 18 of different fields of view. Display 34 may comprise a display, such as a screen, of a computing system, for example, a computer, a personal digital assistant, or a cell phone.

A component of imaging system 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to imaging system 10 without departing from the scope of the invention. The components of imaging system 10 may be integrated or separated. For example, display 34 may be physically separated from, but in communication with, the other components of imaging system 10. Moreover, the operations of imaging system 10 may be performed by more, fewer, or other components. For example, the operations of camera 20 and image processor 24 may be performed by one component, or the operations of image processor 24 may be performed by more than one component. Additionally, operations of imaging system 10 may be performed using any suitable logic. As used in this document, “each” refers to each member of a set or each member of a subset of a set.

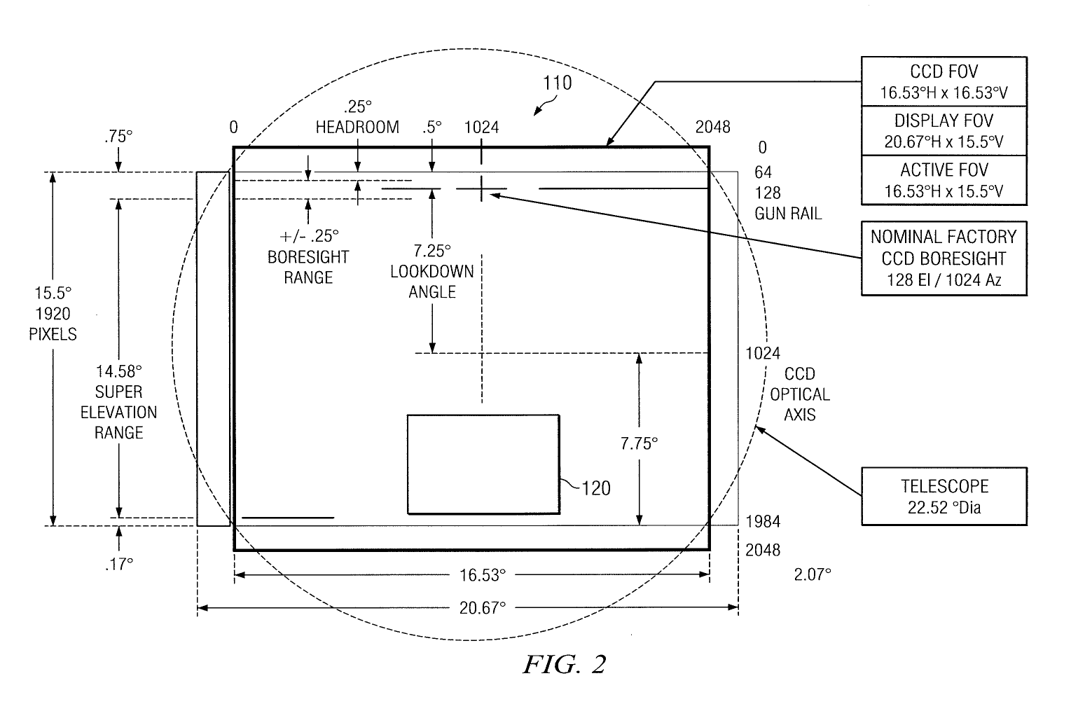

FIGS. 2 and 3 illustrate examples of wide and narrow FOV images displayed by one embodiment of imaging system 10. The values presented here are examples only; other suitable values may be used.

FIG. 2 illustrates an example of a wide FOV image 110 that includes an outline 120 indicating a narrow FOV image. In the example, the CCD field of view is 16.53° H×16.53° V, and the CCD pixel area is 2048H×2048 V. The display field of view is 20.67° H×15.50° V, and the display pixel area is 2048H×1920 V. The active field of view is 16.53° H×15.50° V, and the active pixel area is 2048H×1920 V. The field of view per pixel in the vertical direction is 15.50°/1920 pixels=0.00807°/pixel.

Wide FOV image 110 may have a wide field of view of 20.67° H×15.5° V and a wide pixel area of 640H×480 V. Wide FOV image 110 may have a border, for example, a 2.07° H border on one or both sides. In the vertical direction, 480 out of 1920 pixels are displayed, that is, every 4th row is displayed. 2048 rows−1920 rows=128 rows are not displayed. In the horizontal direction, 640 out of 2560 pixels are displayed, that is, every 4th column is displayed.

The field of view per pixel in the vertical direction is 15.5°/480 pixels 0.0323°/pixel, yielding 0.574 G-mil/pixel. In the horizontal direction, the field of view displayed by CCD is 2048/4 pixels*0.0323°/pixel=16.53°, which yields a (20.67°−16.53°)/2=2.07° border on each side.

FIG. 3 illustrates an example of a narrow FOV image 150. In the example, the CCD, display, and active fields of view are 5.16° H×3.87° V, and the CCD, display, and active pixel areas are 640H×480 V.

The field of view per pixel in the vertical direction is 3.87°/480 pixels=0.00807°/pixel, yielding 0.1435 G-mil/pixel. In the vertical direction, 480 pixels*0.00807°/pixel=3.87°, and in the horizontal direction, 640 pixels*0.00807°/pixel 5.16°

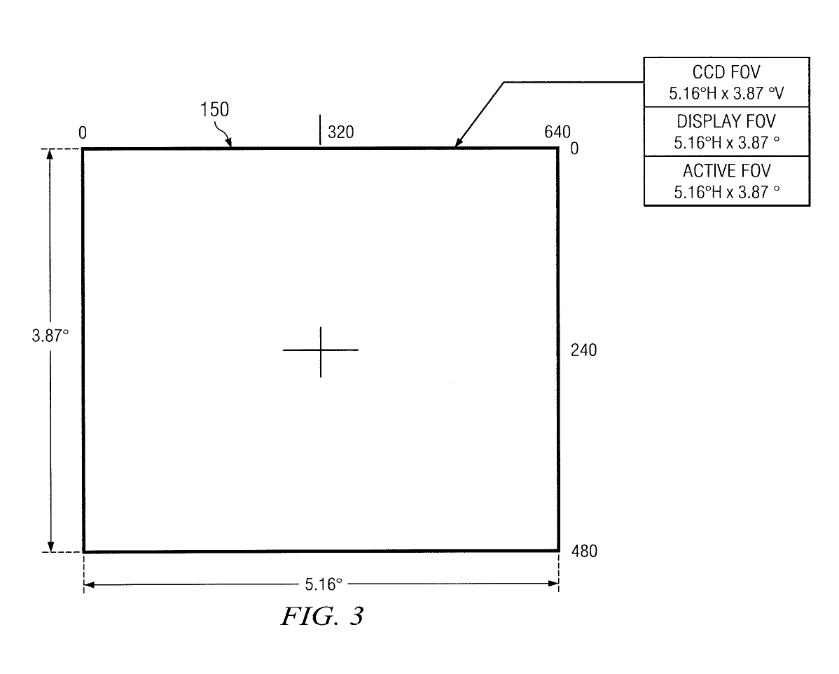

FIG. 4 illustrates one embodiment of a method for generating images 18 of different fields of view. The method starts at step 210, where camera 20 receives light reflected from scene 14. Camera 20 generates image data from the reflected light at step 214.

Image processor 24 receives an instruction to generate a wide FOV image 46 at step 218. Instructions may be generated in response to a user setting, a timed setting, or a default setting. Image processor 24 generates a first image signal that is operable to yield wide FOV image 46 at step 222, and sends the first image signal to display 34. Display 34 displays wide FOV image 46 according to the first image signal at step 224.

Image processor 24 receives an instruction to generate a narrow FOV image 48 at step 228. Instructions may be generated in response to a user setting, a timed setting, or a default setting. In one example, the instruction may be generated in response to a user selecting a portion, such as narrow FOV image 48, from wide FOV image 46. Image processor 24 generates a second image signal that is operable to yield narrow FOV image 48 at step 232, and sends the first image signal to display 34. Display 34 displays narrow FOV image 48 according to the second image signal at step 236.

Modifications, additions, or omissions may be made to the method without departing from the scope of the invention. The method may include more, fewer, or other steps. Additionally, steps may be performed in any suitable order.

Certain embodiments of the invention may provide one or more technical advantages. A technical advantage of one embodiment may be that an imaging system generates images of different fields of view. Another technical advantage of one embodiment may be that a gimbal system stabilizes the imaging system.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. An apparatus comprising:
a camera configured to:
receive light reflected from a scene; and
generate image data from the light, the image data representing the scene; and
an image processor configured to:
receive the image data;
generate a first image signal according to the image data, the first image signal operable to yield a first image representing a first field of view of the scene; and
generate a second image signal according to the image data, the second image signal operable to yield a second field of view of the scene, the second field of view different from the first field of view.

2. The apparatus of claim 1, the image processor further configured to:
generate the first image signal by:
selecting a first set of pixels from the image data; and
generate the second image signal by:
selecting a second set of pixels from the image data, the second set different from the first set.

3. The apparatus of claim 1, the image processor further configured to:
generate the first image signal by:
selecting a set of pixels from the image data; and
generate the second image signal by:
selecting a subset of the set of pixels.

4. The apparatus of claim 1, the image processor further configured to generate the second image signal by:
calculating a field of view contributed by each pixel of the first image; and
calculating a number of pixels for the second image from the field of view contributed by each pixel of the first image.

5. The apparatus of claim 1, the image processor further configured to generate the second image signal by:
calculating a field of view contributed by each pixel of the first image; and
determining the second field of view from the field of view contributed by each pixel of the first image.

6. The apparatus of claim 1, the image processor further configured to:
receive an instruction to generate the second image signal, the instruction generated in response to a user selecting a portion of the first image.

7. The apparatus of claim 1, wherein:
the image data comprises:
first image data corresponding to the first field of view; and
second image data corresponding to the second field of view; and
the image processor is further configured to:
generate the first image signal by generating the first image signal according to the first image data; and
generate the second image signal by generating the second image signal according to the second image data.

8. The apparatus of claim 1, the image processor further configured to:
generate the first image signal by processing the image data to generate the first image signal; and
generate the second image signal by processing the image data to generate the second image data.

9. The apparatus of claim 1, further comprising:
a display configured to display the first image and the second image.

10. The apparatus of claim 1, further comprising:

11. A method comprising;
receiving, at a camera, light reflected from a scene;
generating image data from the light, the image data representing the scene;
generating, by an image processor, a first image signal according to the image data, the first image signal operable to yield a first image representing a first field of view of the scene; and
generating a second image signal according to the image data, the second image signal operable to yield a second field of view of the scene, the second field of view different from the first field of view.

12. The method of claim 11, wherein:
generating the first image signal further comprises:
selecting a first set of pixels from the image data; and
generating the second image signal further comprises:
selecting a second set of pixels from the image data, the second set different from the first set.

13. The method of claim 11, wherein;
generating the first image signal further comprises:
selecting a set of pixels from the image data; and
generating the second image signal further comprises:
selecting a subset of the set of pixels.

14. The method of claim 11, wherein generating the second image signal further comprises:
calculating a field of view contributed by each pixel of the first image; and
calculating a number of pixels for the second image from the field of view contributed by each pixel of the first image.

15. The method of claim 11, wherein generating the second image signal further comprises:
calculating a field of view contributed by each pixel of the first image; and
determining the second field of view from the field of view contributed by each pixel of the first image.

16. The method of claim 11, further comprising:
receiving an instruction to generate the second image signal, the instruction generated in response to a user selecting a portion of the first image.

17. The method of claim 11, wherein:
the image data comprises:
first image data corresponding to the first field of view; and
second image data corresponding to the second field of view; and
wherein:
generating the first image signal further comprises generating the first image signal according to the first image data; and
generating the second image signal further comprises generating the second image signal according to the second image data.

18. The method of claim 11, wherein:
generating the first image signal further comprises processing the image data to generate the first image signal; and
generating the second image signal further comprises processing the image data to generate the second image data.

19. The method of claim 11, further comprising:
stabilizing the camera using a gimbal system.

20. An apparatus comprising:
a camera configured to:
receive light reflected from a scene; and
generate image data from the light, the image data representing the scene;
an image processor configured to:
receive the image data;
generate a first image signal according to the image data by selecting a set of pixels from the image data, the first image signal operable to yield a first image representing a first field of view of the scene;
receive an instruction to generate a second image signal, the instruction generated in response to a user selecting a portion of the first image; and
generate the second image signal according to the image data by selecting a subset of the set of pixels, the second image signal operable to yield a second field of view of the scene, the second field of view different from the first field of view, the second image signal generated by:
calculating a field of view contributed by each pixel of the first image; and
calculating a number of pixels for the second image from the field of view contributed by each pixel of the first image;
a display configured to display the first image and the second image; and
a gimbal system configured to stabilize the camera.
